(19) United States
(12) Patent Application Publication
(10) Pub. No.: US 2004/0138035 A1
(43) Pub. Date: Jul. 15, 2004

(54) Stamping machines

(76) Inventor: David Brian Boulton, Nottingham (GB)

Correspondence Address: Gunnar G Leinberg, Nixon Peabody, Clinton Square, PO Box 31051, Rochester, NY, 14603, US

(21) Appl. No.: 10/469,639

(22) PCT Filed: Mar. 6, 2002
(86) PCT No.: PCT/GB02/01027

(30) Foreign Application Priority Data
Mar. 8, 2001 (GB) 0105672.0
Jun. 27, 2001 (GB) 0115779.1

(51) Int. Cl. B31B 1/00

(52) U.S. Cl. 493/51

(57) ABSTRACT

There is described a stamping machine for the separation of shaped pieces, formed by cutting a sheet of material, from the remainder of the material. The machine incorporates a male die (13) with a plurality of projections corresponding to the shape of said shaped pieces. The male die comprises a plate of rigid synthetic foam material from which said projections extend. The projections are formed integrally with the plate. The die may be manufactured by machining material away from a plate of rigid synthetic foam material, eg using a routing machine operating under computer numerical control.

This invention relates to improvements in or relating to stamping machines, ie machines for the automated separation from sheets of material of shaped components formed by cutting of such sheets in a previous operation. Such a stamping machine may form part of an integrated machine of the type known as a cutting-and-creasing machine, in which sheet material traverses a plurality of processing stations.

Cartons and other items are commonly formed from blanks. Such blanks are cut from sheet material such as card or plastics sheet and also creased to facilitate the folding necessary to assemble the finished article. The cutting is carried out by rule die cutting, the shaped pieces resulting from the cutting then being separated from the waste portion of the sheet.

In an automated machine for forming blanks as described above, sheet stock is normally fed to a reciprocating cutter-creaser. The cutter-creaser makes cuts in the sheet, thereby defining the blank(s) and a surrounding waste section. However, the sheet remains intact because the blanks remain connected to the waste by small bridges or webs. At the same time, creases may be formed in the sheet where the finished article is to be formed by folding. Thereafter, the sheet is conveyed to a separator, at which the blank(s) and the waste are separated from each other. The blanks are collected, while the waste material is transported away to a waste receptacle.

The separator includes a lower or female die for supporting either the waste or the blanks and a reciprocating upper die for pressing the remainder of the material out of the sheet. Where the upper die acts on the blanks, pressing the blanks out of the sheet, the operation is commonly referred to as “blanking”. Where the upper die acts on the waste, the operation is commonly known as “stripping”.

In a blanker, the lower, or female, die normally has one or more openings through which the blanks are pressed by the upper or male die. The opening in the lower die must therefore have the same shape as the blank and this opening must be only slightly larger than the blank. The male die must have the same shape as the opening in the lower die and must be able to pass through the opening in the lower die with a small clearance.

Conventionally, the male die is formed as an array of steel pins mounted on a support and arranged to have nearly the same shape and size as the blank. The sheet is conveyed along the upper surface of the lower die and positioned with the blank aligned with the opening in the lower die. The upper die then presses the blank through the opening in the lower die.

In a stripper, the arrangement is analogous to the blanker, save that it is the waste material that is pressed away from the sheet.

Arrangements such as that described above suffer from a number of disadvantages. First, each time the shape of the product is changed, the pins on the upper die must be removed and remounted in a new pattern. The number of pins may be very large and they must be positioned precisely. The change-over from one product to another is therefore time-consuming and this leads to lengthy interruptions in the operation of the machine.

In addition, the reciprocating pins may represent a safety hazard to personnel operating the machine. Although such action may be strictly forbidden, in the event of blockage or jamming of the machine, an operator may be tempted to insert his or her hand between the male and female dies, with a considerable risk of injury should operation of the machine recommence. The pins may also represent a risk of damage to the machine itself, eg if they are misaligned or become distorted.

One attempt to address these problems is disclosed in U.S. Pat. No. 4,921,154. This document discloses cooperating male and female dies formed from a single sheet of plywood. However, such an approach does itself have certain drawbacks. For instance, the male dies must correspond precisely to the shape of the blanks and yet must pass freely through the openings that constitute the female die, and this may be difficult to achieve in practice. Furthermore, the male dies cut from the sheet must be supported for reciprocating motion above the female die and this requires precise positioning of the male dies.

DE-U-29813113 discloses a separating die formed by cutting, using a high pressure water jet, from a rigid foam material. The die is fixed to a support plate by means of adhesive. In order to facilitate positioning of the die on the support plate, the die is formed with a central aperture and the support plate has a similarly shaped and dimensioned aperture. By aligning the apertures in the die and the support plate the die is accurately positioned on the support plate. Obviously, this means that a particular support plate must be prepared for each product and the arrangement is therefore rather wasteful.

There has now been devised an improvement to machines of the general type described above, which overcomes or substantially mitigates the above-mentioned or other disadvantages of the prior art.

According to a first aspect of the invention there is provided a stamping machine for the separation of shaped pieces, said pieces being formed by cutting a sheet of material, from the remainder of the material, said machine comprising a male die with a plurality of projections corresponding to the shape of said shaped pieces, wherein said male die comprises a plate of rigid synthetic foam material from which said projections extend, said projections being formed integrally with said plate.

In another aspect of the invention, there is provided a male separating die suitable for the separation of shaped pieces from a sheet of material, the separating die comprising a plate of rigid synthetic foam material from which a plurality of projections extend, said projections being formed integrally with said plate.

The stamping machine and separating die according to the invention are advantageous primarily in that the male die appropriate to a particular product may be prepared precisely and rapidly. One such die, suitable for one particular product, may rapidly be removed and replaced with another, suitable for the separation of cut shapes of a different form. Delays caused by the need to change dies when products of different type are produced are thereby minimised. Furthermore, although the die is rigid enough to perform its function, it is nonetheless rather less rigid than the steel pins and the like used in the prior art. The hazard presented to operators of the machine is therefore correspondingly lower, as is the risk of damage to the machine itself. The die is also of low cost, both in terms of materials and manufacturing labour, and is low in weight and hence easy to handle. The die can also be disposed of easily when no longer required. The die can also be easily stored for re-use at a future date.

The plate which constitutes the male die is described as rigid, but by this is meant simply that the die is of material of sufficient stiffness and durability that it retains its form while being manufactured and during repeated use. The material may nonetheless be somewhat compressible. The material should also be relatively easily machined, to facilitate manufacture of the die.

To provide additional rigidity and support and rigidity, the plate of foam material is preferably mounted upon, and/or bonded to, a backplate of a suitably stiff material. One such material may be wood, eg plywood, or rigid plastics material.

The plate, or the assembly of plate and backplate, is preferably held in a frame to facilitate mounting of the die in the machine. The plate may be adhered to the backplate by adhesive and/or mechanical fasteners such as screws.

A suitable material for the plate is a closed cell foam of relatively high density. One example of a suitable material is polyethylene foam.

For most applications, the material that makes up the plate may have a thickness of a few tens of millimetres, eg 20 to 60 mm.

The projections that make up the die may be formed by removal of material from one surface of the plate. Such an operation may be carried out by routing, eg using a suitable routing machine, preferably operating under computer numerical control (CNC). Suitable machines that may be used for this purpose are, for example, those supplied by Axyz Automation, Inc of 5330 South Service Road, Burlington, Ontario, L7L 5L1, Canada.

Thus, according to a further aspect of the invention, there is provided a method for the manufacture of a male die for use in a stamping machine for the separation of shaped pieces from a sheet of material, which method comprises the steps of

a) providing a plate of rigid synthetic foam material;

b) removing material from one surface of said plate so as to form a plate of reduced thickness with projections extending therefrom in a pattern corresponding to the shape of the pieces that are to be removed from the sheet of material.

As explained above, removal of material from one surface of the plate is preferably carried out by a suitable machine tool, eg a routing machine, most preferably operating under computer numerical control.

Typically, the die will be formed by routing away up to one-half of the thickness of the foam material. The thickness of material removed will typically be 5-25 mm, eg 10-20 mm.

Where small regions of material are to be displaced from the sheet by the male die, it may be convenient for additional rigid die elements akin to the steel pins used in the prior art to be mounted on the plate of foam material (or in the backplate on which the plate is mounted).

As in a conventional arrangement, the male die according to the invention preferably cooperates with a female die which supports the sheet of material from which the shaped pieces are separated.

As explained above, the male die may act upon the blanks that are thus separated from surrounding waste material (as in a “blanker”) or the male die may act upon the waste material (in a “stripper”). Particularly in the former case, the male die may be assembled from a plurality of die elements that are cut from foam and secured to a support, rather than being formed integrally with a foam plate which is then secured to a support. In such a case, the foam die elements are most preferably secured to the support by means of mechanical fasteners such as bolts. The cutting operation by which the die elements are cut from the foam will also include the forming of bores through the die elements through which such fasteners may pass, and the location of such bores will correspond to the positions of fixing points formed on the support, thereby leading to precise positioning of the die elements on the support. Thus, the precise desired shape of die element may be machined from the foam starting material, and the precise position of the die element on the support determined by precise positioning of the bore(s) by which the die element is fastened to the support. Like the machining of the shape of the die element, the positioning and formation of the bore(s) is most preferably carried out under computer numerical control, using a routing machine or the like.

Thus, according to a further aspect of the invention, there is provided a separating die comprising a support to which a plurality of die elements are secured by means of mechanical fasteners passing through the die elements, each die element being machined from a rigid synthetic foam material.

The separating die according to this aspect of the invention offers considerable advantages over, for instance, the arrangement described in DE-U-29813113, in that the same support may be used with die elements of differing dimensions die elements positioned in different locations on the support. In the prior art arrangement, positioning of die elements on the support is achieved by forming correspondingly-shaped openings in both support and die element and aligning those openings, the die element then being bonded to the support by adhesive. Clearly, this means that a new support is required for every different die that is to be assembled. In the invention, by contrast, the support may be formed with an array of predefined fixing points and bores through the die elements formed in exactly the right position to be aligned with selected fixing points. Thus, the same support may be used repeatedly, a particular set of die elements being fastened to the support in the desired locations for one job, and then removed and replaced with a different set of die elements for another job.

According to another aspect of the invention, therefore, there is provided a separating die comprising a support to which is secured a plurality of die elements, the support being formed with an array of fixing points and the die elements being secured to the support by mechanical fasteners passing through the die elements and engaging the support at selected fixing points.

The mechanical fasteners are most preferably bolts passing through the die elements. The heads of the bolts are most preferably accommodated within counter-sinks formed in the terminal portions of the bores through die elements. The depth of the counter-sink may be chosen according to the length of the bolt, so that the bolt engages with the support but does not project substantially beyond the support. The array of fixing points is most conveniently made up of a regular array of holes in the support. The holes may be threaded for engagement with the bolts passing through the die elements. More commonly, however, the bolts engage with nuts at the reverse side of the support, a nut preferably being permanently fixed to the reverse side of the support at each fixing point.

It will be appreciated that the sheet material, while most commonly of paper or card, may alternatively be any of a number of other materials, eg plastics sheet, foam sheet, etc.

The invention will now be described in greater detail, by way of example only, with reference to the accompanying drawings, in which

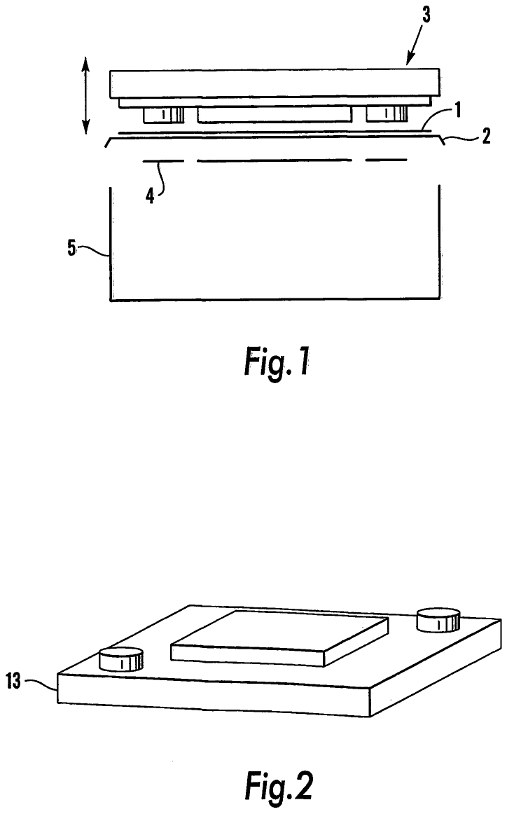

FIG. 1 is a schematic view of a stamping station forming part of a cutting and creasing machine, the stamping station being equipped with a first embodiment of a stamping die in accordance with the invention;

FIG. 2 is a perspective view of the stamping die, as manufactured and prior to installation in the machine of FIG. 1;

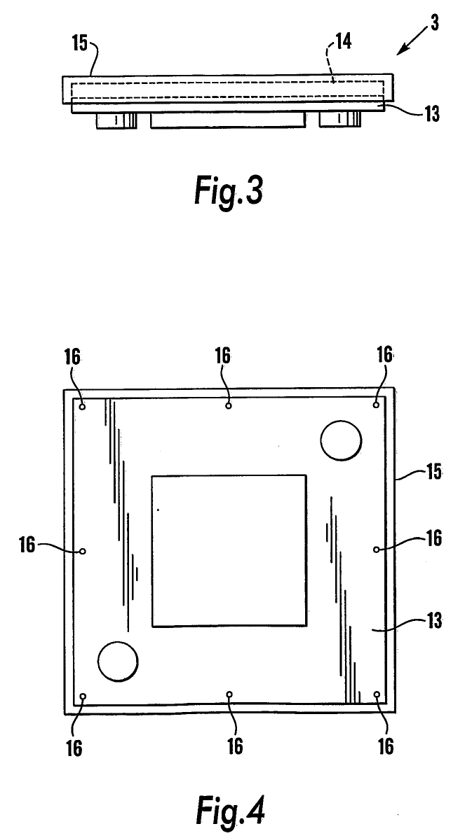

FIG. 3 is a side view of the stamping die, mounted in a frame;

FIG. 4 is a plan view of the stamping die;

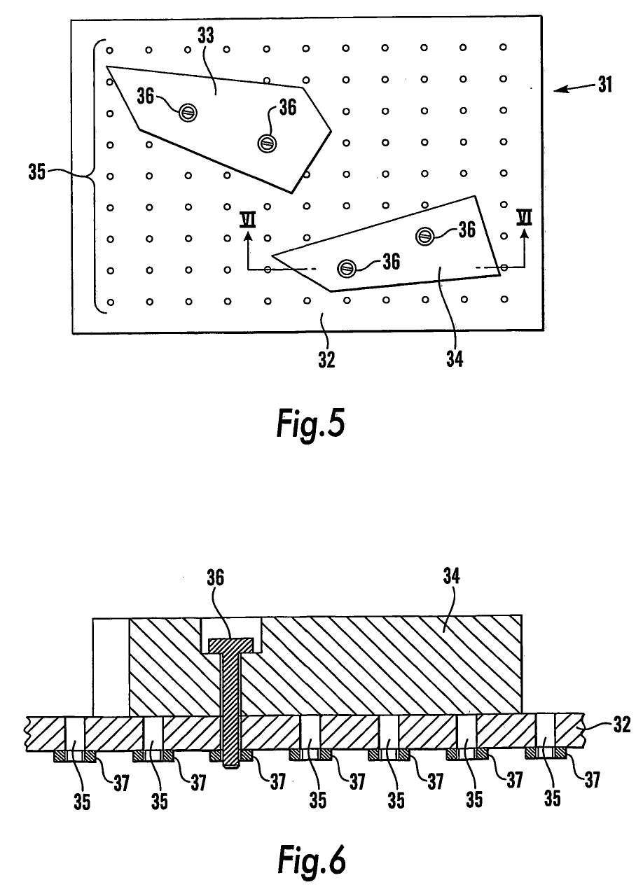

FIG. 5 is a plan view of a second embodiment of a separating die according to the invention; and

FIG. 6 is a sectional view on the line VI-VI in FIG. 5.

Referring first to FIG. 1, a stamping station forms part of an otherwise conventional cutting and creasing machine. The function and construction of such a machine will be familiar to those skilled in the art. Briefly, the machine is used to cut appropriately shaped pieces, typically blanks for cartons or other articles to be formed by folding of sheet material, from sheet material (eg card or plastics sheet etc) fed, either in continuous form or as discrete sheets, to the machine. In the following description, the pieces formed and cut from the sheet material will be referred to as “blanks”, but it should be realised that the invention is not limited to the production of blanks for subsequent processing by folding, gluing etc as in the production of cartons. Similarly, the sheet material will be described as “card”, but it will again be appreciated that the invention may be applied to any suitable form of sheet material.

In a processing station (not shown in the drawings) upstream of that illustrated schematically in FIG. 1, the shapes of the blanks are formed in the sheet material. This will normally involve die cutting of the blanks, which however remain attached to the surrounding card sheet by narrow webs of material so that the blanks are not dislodged from the sheet too early in the manufacturing process. At the same or a further processing station (again not illustrated), appropriate creases are also formed in the blanks, to facilitate subsequent folding. These stages in the procedure are entirely conventional, and do not form part of the present invention. The card sheets are transported automatically from one processing station to another by mechanical means, eg gripper bars or conveyors, again in conventional manner.

In a final stage of processing in the cutting and creasing machine, the blanks are separated from the card. This operation is carried out at the stamping station illustrated in FIG. 1. At this station, the card sheet 1 rests on a suitable support 2 which is configured so as not to interfere with the stamping operation described below. This detailed description of embodiments of the invention will refer to dies acting upon the blanks so as to separate the blanks from residual waste material (a “blanking” operation), but it will be appreciated that the waste material may similarly be acted upon by appropriately formed dies so as to separate the waste material from the blanks (a “stripping” operation),

A stamping die assembly 3 reciprocates above the card sheet 1 in such a manner that the lower face of the die assembly bears against the parts of the card sheet 1 in which blanks are formed so as to press the blanks out of the card sheet 1. Blanks 4 dislodged in this way fall into a collection bin 5.

The support 2 may take any suitable form. It may, for instance, be in effect a female die with a shape conforming to the shape of the waste card material which surrounds the blanks. Alternatively, the support 3 may take the form of a grid, eg wire grid, which supports the card in regions between the blanks that are to be punched out of the card.

The construction of the stamping die assembly 3 is shown in more detail in FIGS. 2 to 4. It comprises a die 13, which is mounted on a rigid backplate 14 which in turn is fitted into a frame 15.

The die 13 is generally square and consists of a slab of high-density, closed cell polyethylene foam. The dimensions of the slab are typically 720 mm × 1020 mm, with a thickness of typically 35 mm or 54 mm.

The actual form of the die is formed in one face of the die 13 by a routing operation to a depth of approximately one-half of the overall thickness of the slab. The routing operation is carried out under precise computer numerical control so that the surface relief formed in the face of the slab corresponds to the shape of the blank(s) to be pressed from the card sheet 1, both in terms of the shape and dimensions of the blanks and also their precise position on the slab. In the drawings, the relief profile is shown, purely for simplicity and ease of illustration, as one square and two circular formations. In practice, the profile will normally be of considerably more complex form, corresponding to the complex shape of the blank or blanks to be pressed from the sheet. In practice also, the profile of the die may correspond to a plurality of blanks of identical form, rather than a number of differently shaped components.

The die 13 is fixed to a rigid backplate 14 which may typically be of 15 mm or 18 mm grade plywood. This fixing is most conveniently achieved using mechanical fixings such as screws 16 (or bolts etc) which may be passed through the die 13 at any suitable positions, eg spaced positions around the periphery of the die 13 as indicated in FIG. 4. The backplate 14 is in turn mounted in the frame 15 which is adapted for mounting at the stamping station for reciprocating motion as shown in FIG. 1.

Turning now to FIGS. 5 and 6, a second embodiment of a separating die according to the invention is generally designated 31. The die 31 comprises a support plate 32 to which, in the illustrated embodiment, two irregularly shaped die elements 33,34 are fixed.

The support plate 32 is rectangular and comprises a sheet of plywood material, though other materials such as rigid plastics may alternatively be used. The plate is formed with a regular array of fixing holes 35, a threaded nut 37 (see FIG. 5) being fixed to the reverse side of the plate 32 in alignment with each of the fixing holes 35.

The die elements 33,34 are machined from rigid synthetic foam material. The die elements depicted in FIG. 5 are schematic, being irregularly shaped and not representative of the typical shape that such dies would have in practice. Two differently-shaped die elements 33,34 are shown, whereas in practice (as for the first embodiment described above) a plurality of similarly-shaped die elements is more likely to be used in practice.

Each die element 33,34 is secured to the plate 32 by means of two bolts 36 that pass through bores formed in the die elements 33,34 at positions corresponding to the positions of selected fixing holes 35. Thus, the machining of the die elements 33,34 involves not only cutting of the die elements 33,34 to the desired shape and dimensions, but also forming of the bores at precise positions corresponding to the positions of selected fixing holes 35 when the die element is correctly positioned on the support plate 32. The top (as viewed in the Figures) portion of each bore in the die elements 33,34 is formed as a counter-sink to accommodate the head of the bolt 36, the depth of the counter-sink being chosen such that the tip of the bolt 36 engages the nut 37 but does not project substantially beyond it.

It will be appreciated that the support plate 32 in this embodiment is reusable, the die elements 33,34 being released from the support plate 32 simply by loosening of the bolts 36. Other die elements may then be positioned on the support plate at appropriate positions.

1. A stamping machine for the separation of shaped pieces, said pieces being formed by cutting a sheet of material, from the remainder of the material, said machine comprising a male die with a plurality of projections corresponding to the shape of said shaped pieces, wherein said male die comprises a plate of rigid synthetic foam material from which said projections extend, said projections being formed integrally with said plate.

2. A stamping machine as claimed in claim 1, wherein the plate is mounted upon and/or bonded to a backplate.

3. A stamping machine as claimed in claim 2, wherein the backplate is made of plywood.

4. A stamping machine as claimed in any one of claims 2 or 3, wherein the plate is adhered to the backplate by adhesive and/or mechanical fasteners.

5. A stamping machine as claimed in any preceding claim, wherein the plate, or the assembly of plate and backplate, is held in a frame to facilitate mounting of the die in the machine.

6. A stamping machine as claimed in any preceding claim, wherein the plate is made of a closed cell foam of relatively high density.

7. A stamping machine as claimed in claim 6, wherein the plate is made of polyethylene foam.

8. A stamping machine as claimed in any preceding claim, wherein the plate has a thickness of between 20 and 60 mm.

9. A stamping machine as claimed in any preceding claim, wherein the projections are formed by removal of material from one surface of the plate.

10. A stamping machine as claimed in claim 9, wherein the material is removed from the surface of the plate by a routing machine.

11. A stamping machine as claimed in claim 10, wherein the routing machine used to remove material from the surface of the plate is operated under computer numerical control.

12. A stamping machine as claimed in any one of claims 9 to 11, wherein the material removed from the surface of the plate has a thickness of between 5 and 25 mm.

13. A stamping machine as claimed in any one of claims 9 to 11, wherein the material removed from the surface of the plate has a thickness of between 10 and 20 mm.

14. A stamping machine as claimed in any preceding claim, wherein additional rigid die elements are mounted on the plate or backplate.

15. A stamping machine as claimed in any preceding claim, wherein the male die cooperates with a female die supporting the sheet material.

16. A stamping machine as claimed in any preceding claim, wherein the sheet material is paper or card.

17. A stamping machine as claimed in any preceding claim, wherein the sheet material is plastic or foam.

18. A male separating die suitable for the separation of shaped pieces from a sheet of material, the separating die comprising a plate of rigid synthetic foam material from which a plurality of projections extend, said projections being formed integrally with said plate.

19. A die as claimed in claim 18, wherein the plate is mounted upon and/or bonded to a backplate.

20. A die as claimed in claim 19, wherein the backplate is made of plywood.

21. A die as claimed in any one of claims 19 or 20, wherein the plate is adhered to the backplate by adhesive and/or mechanical fasteners.

22. A die as claimed in any one of claims 18 to 21, wherein the plate, or the assembly of plate and backplate, is held in a frame to facilitate mounting of the die in a stamping machine.

23. A die as claimed in any one of claims 18 to 22, wherein the plate is made of a closed cell foam of relatively high density.

24. A die as claimed in claim 23, wherein the plate is made of polyethylene foam.

25. A die as claimed in any one of claims 18 to 24, wherein the plate has a thickness of between 20 and 60 mm.

26. A die as claimed in any one of claims 18 to 25, wherein the projections are formed by removal of material from one surface of the plate.

27. A die as claimed in claim 26, wherein the material is removed from the surface of the plate by a routing machine.

28. A die as claimed in claim 27, wherein the routing machine used to remove material from the surface of the plate is operated under computer numerical control.

29. A die as claimed in any one of claims 26 to 28, wherein the material removed from the surface of the plate has a thickness of between 5 and 25 mm.

30. A die as claimed in any one of claims 26 to 28, wherein the material removed from the surface of the plate has a thickness of between 10 and 20 mm.

31. A die as claimed in any one of claims 18 to 30, wherein additional rigid die elements are mounted on the plate or backplate.

32. A method for the manufacture of a male die for use in a stamping machine for the separation of shaped pieces from a sheet of material, which method comprises the steps of:
a) providing a plate of rigid synthetic foam material; and
b) removing material from one surface of said plate so as to form a plate of reduced thickness with projections extending therefrom in a pattern corresponding to the shape of the pieces that are to be removed from a sheet of material.

33. A method as claimed in claim 32, wherein the plate is made of a closed cell foam of relatively high density.

34. A method as claimed in claim 33, wherein the plate is made of polyethylene foam.

35. A method as claimed ed in any one of claims 32 to 34, wherein the plate has a thickness of between 20 and 60 mm.

36. A method as claimed in any one of claims 32 to 35, wherein the material is removed from the surface of the plate by a routing machine.

37. A method as claimed in claim 36, wherein the routing machine used to remove material from the surface of the plate is operated under computer numerical control.

38. A method as claimed in any one of claims 32 to 37, wherein the material removed from the surface of the plate has a thickness of between 5 and 25 mm.

39. A method as claimed in any one of claims 32 to 38, wherein the material removed from the surface of the plate has a thickness of between 10 and 20 mm.

40. A male separating die suitable for the separation of shaped pieces from a sheet of material, the separating die comprising a support to which a plurality of die elements are secured by means of mechanical fasteners passing through the die elements, each die element being machined from a rigid synthetic foam material.

41. A die as claimed in claim 40, wherein the support is made of plywood.

42. A die as claimed in claim 40 or claim 41, wherein the support is held in a frame to facilitate mounting of the die in a stamping machine.

43. A die as claimed in any one of claims 40 to 42, wherein the die elements are made of a closed cell foam of relatively high density.

44. A die as claimed in claim 43, wherein the die elements are made of polyethylene foam.

45. A die as claimed in any one of claims 40 to 44, wherein the die elements have a thickness of between 20 and 60 mm.

46. A die as claimed in any one of claims 40 to 45, wherein the die elements are cut from foam material by a routing machine.

47. A die as claimed in claim 46, wherein the routing machine is operated under computer numerical control.

48. A die as claimed in any one of claims 40 to 47, wherein the mechanical fasteners are bolts.

49. A die as claimed in claim 48, wherein the bolts pass through bores in the die elements, the bores being counter-sunk to accommodate the heads of the bores.

50. A die as claimed in any one of claims 40 to 49, wherein the support is formed with an array of fixing points, and the mechanical fasteners engage the support at selected fixing points.

51. A method for the manufacture of a die as claimed in nay one of claims 40 to 50, which method comprises the steps of:
a) providing a plate of rigid synthetic foam material;
b) cutting from said plate a plurality of die elements, said die elements corresponding in shape to pieces to be separated from a sheet of material; and
c) securing said die elements to a support by means of mechanical fasteners passing through the die elements.

52. A method as claimed in claim 50, wherein, prior to cutting of the die elements from the plate, bores are formed in the parts of the plate that are cut out to form the die elements, the bores being adapted to receive the mechanical fasteners.

53. A method as claimed in claim 51, wherein the bores are counter-sunk.

54. A method as claimed in claim 50 or claim 51, wherein the support is formed with an array of fixing points and the bores are formed at positions in the plate such that when the die elements are positioned at desired locations on the support, the bores are in registration with fixing points.

55. A method as claimed in any one of claims 50 to 54, wherein the support is made of plywood.

56. A method as claimed in any one of claims 50 to 55, further comprising the step of mounting the support in a frame to facilitate mounting of the die in a stamping machine.

57. A method as claimed in any one of claims 50 to 56, wherein the die elements are made of a closed cell foam of relatively high density.

58. A method as claimed in claim 57, wherein the die elements are made of polyethylene foam.

59. A method as claimed in any one of claims 50 to 58, wherein the die elements have a thickness of between 20 and 60 mm.

60. A method as claimed in any one of claims 50 to 59, wherein the die elements are cut from foam material by a routing machine.

61. A method as claimed in claim 60, wherein the routing machine is operated under computer numerical control.

62. A method as claimed in any one of claims 50 to 61, wherein the mechanical fasteners are bolts.
